(19) United States
(12) Patent Application Publication
(10) Pub. No.: US 2024/0193519 A1
(43) Pub. Date: Jun. 13, 2024

(54) SYSTEMS AND METHODS FOR SYSTEM-WIDE GRANULAR ACCESS RISK MANAGEMENT

(71) Applicant: SailPoint Technologies, Inc., Wilmington, DE (US)

(72) Inventor: Jeremy Holovacs, Pensacola, FL (US)

(21) Appl. No.: 18/077,644

(22) Filed: Dec. 8, 2022

(51) Int. Cl. G06Q 10/06; G06F 16/2457; G06F 16/248

(52) U.S. Cl. CPC G06Q 10/0635; G06F 16/24573; G06F 16/248

(57) ABSTRACT

A database-driven analytics engine can break permission data from different enterprise-class systems down to the smallest components and roll them back up one level at a time, to permission groups, to business functions, then to risks (rules). This processing produces a list of complete permissions on a per user basis and allows the engine to conduct access risk analyses across the different enterprise-class systems. Responsive to a multi-system analysis request, the engine can query a database for the list of complete permissions on a per user basis and analyze in view of user permissions granted to each user and business functions assigned to the respective user in a system-agnostic manner and determine user access risks based on rules governing those business functions. Insights from this multi-system analysis can be used for generating a report on system-wide access risks. The report can be presented through a user interface.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

This disclosure relates generally to computer security. In particular, this disclosure relates to access risk management in a distributed and networked enterprise computing environment. Even more specifically, this disclosure relates to systems, methods, and computer program products for aggregating and highlighting risks across multiple system types for enterprise-wide Segregation of Duties concerns.

### BACKGROUND OF THE RELATED FIELD

Segregation of Duties (SoD), also known as Separation of Duties, generally refers to having more than one person to complete a task. In an organization, having one person being able to do a multiple of related tasks can be dangerous. It can create a conflict of interest, and potentially lead to embezzlement or abuse. However, despite being inherently vulnerable to abuse, some business functions still need to be performed. Thus, organizations and companies alike would want to have a definitive list of who can perform these functions so that risk(s) can be reasonably mitigated. Yet, it can be extremely complicated, multi-faceted, and difficult to organize and examine all the information in bulk and visualize with a complete list of risks and mitigations for efficient and effective access risk management.

Today, computer-implemented tools are used by companies to gain insights on potential risks, including SoD and Sensitive Access (SEN), that may exist in their systems such as enterprise resource planning (ERP) systems. These insights can be used by external auditors and internal compliance teams to help ensure due diligence is performed to reduce business risks.

Unfortunately, with today's computer-implemented tools, detecting an SOD risk in large business applications (e.g., SAP, ORACLE EBS, MICROSOFT DYNAMICS, SALESFORCE, WORKDAY, etc.) remains difficult to do. One reason is that users of these large business applications (which are also referred to herein as “systems”) often have multiple ways of accomplishing the same thing. This means that searching for some simple set of permissions does not adequately meet the risk identification and coverage needs of today's companies.

Additionally, in current corporate landscape of mergers and acquisitions, different sides of an SOD risk may be present in completely different business applications. These disparate systems are organized and managed in completely different ways. The disparate nature of these systems made identifying distributed risks across these systems a highly manual, inefficient, and incomplete process.

To this end, a custom solution could be created, on a per-system basis, for identifying SoD risks in a business application. Alternatively, a service that specializes in a single business application could be used to identify the sides of a risk, determine the scope of the access, and export the findings, one system at a time (e.g., analyzing an SAP system for access risks and then separately analyzing an ORACLE system for access risks). Then, a custom software may be written to link the risks or the risks could be manually linked together. This custom, one-system-at-a-time approach is very limited, because each solution is custom-tailored to a company's specific business application suite, and making changes to these complex implementations is a complicated and fragile process. Additionally, simulating (predicting) SoD risks when provisioning users in these disparate systems can only be estimated through entitlement management, which does not necessarily address the true access risks.

### SUMMARY OF THE DISCLOSURE

The invention disclosed herein provides a new approach to access risk management. In some embodiments, the new approach involves programmatically looking at, and solving, the above-stated access risk management problems in a different way. Instead of examining different business applications with different access mechanisms and different processes involved in accomplishing certain business functions in an enterprise, the invention focuses on how a particular business function is permitted to perform in different systems of the enterprise and abstractly represents that particular business function in a uniform business application data model at an abstraction layer above the various systems. The business application data model is adapted to apply to all the business applications with the particular business function. In this way, different systems (e.g., multiple homogeneous business applications or instances of the same system type, multiple heterogenous business applications or instances of different system types) can be treated as one system that can be analyzed (e.g., via a SoD analysis) to detect potential access risks across these different systems.

As those skilled in the art can appreciate, security principals, permissions, business functions, and rules (risks) are security concepts for access risk management. A security principal is an object that is directly associated with permissions. Examples of security principals can include users, groups, and roles (i.e., user objects representing the actual users, group objects representing the actual groups, and role objects representing the actual roles). A permission is a granular right that can be atomically exercised. In this disclosure, a permission is the smallest component of all the systems under examination. A business function involves a collection of permissions needed to perform a business-specific or business-significant task or function (e.g., creating a vendor, paying a vendor, etc.). In this disclosure, a rule represents a potential risk to an enterprise when a certain business function or business functions is/are owned by the same person.

In some embodiments, the invention disclosed herein provides a multi-system granular access management capability that is operable to obtain data (e.g., security principles, user permissions, user profiles, group permissions, etc.) across different systems in a distributed enterprise computing environment, merge the data thus obtained for an access risk analysis such as a SoD analysis, and conduct the access risk analysis to analyze the merged data and detect risks of malicious behavior and fraud across the enterprise.

In some embodiments, the access risk analysis can include running a “system-agnostic” rule set on the data thus merged from the different systems and performing analytics in a more granular way to identify any potential fraud. For instance, instead of performing a single role-based access review or a two-level review, the access risk analysis may examine the merged data at four different levels (e.g., at the permission level, at the permission group level, at the business function level, and at the rule level) to better analyze the data merged from the different systems for malicious patterns and/or activities across these systems.

By separating the interpretation of data, the system-specific mechanisms of collecting relevant data, and the “rules” for defining an access risk, and by allowing the business application ecosystem to be viewed holistically, the invention disclosed herein can greatly accelerate the adoption of an enterprise-wide access risk management policy and can rapidly deliver a much lower-cost solution with considerably less overhead. Additionally, once the systems are part of the uniform business application data model, true simulations for provisioning decisions can be made practically instantly, with a much higher degree of accuracy than can be expected using entitlement-level analysis.

The multi-system granular access management capability disclosed herein enables system-wide granular access management for low-level (e.g., at the permission level) access risk detection across different systems in an enterprise. In some embodiments, the invention disclosed herein can also provide the creation and use of the insights gleaned from the system-wide granular access management capability through a reporting function. In some embodiments, the reporting function can be accessible through a user interface and can be used to report potential access management issues as well as identifying known access management issues.

In some embodiments, a database accessible by an analytics engine, which can be part of an access risk management system, stores outputs from system-specific and enterprise-wide components of the analytics engine. An extract processor is a system-specific component of the analytics engine and is operable to process a system-specific security extract and generates a security extract metadata file from the system-specific security extract. The system-specific security extract is specific to one of a plurality of enterprise-class systems in an enterprise computing environment where the access risk management system operates. The security extract metadata file contains metadata describing security principals (e.g., users, roles, groups, and/or profiles) and associated permissions such as permissions assigned to users, permissions assigned to roles, permissions assigned to groups, etc. The analytics engine stores the security extract metadata file in a cloud storage and stores corresponding stub data for the metadata in the database.

A rulebook compiler is an example of an enterprise-wide component of the analytics engine and is operable to compile a rulebook per a system type and generate a permissions metadata file. The rulebook contains a rule and a plurality of business functions governed by the rule. Each of the plurality of business functions has a set of permissions and a logical operator such as “AND” or “OR.” The permissions metadata file contains metadata describing the rule, the plurality of business functions, the permission sets (groups), and the associated logic. The analytics engine stores the permissions metadata file in a cloud storage and stores corresponding stub data for the metadata in the database.

In some embodiments, the analytics engine is operable to load the permissions metadata file, stream through the security extract metadata file, analyze the plurality of business functions as governed by the rule against the security principals and the associated permissions, determine hits that satisfy the set of permissions and the logical operator, and store the hits in the database. In some embodiments, the hits can include at least a user-to-permission hit, a group-to-permission hit, or a role-to-permission hit.

In some embodiments, in addition to user-to-permission hits, group-to-permission hits, and role-to-permission hits, the database may store permissions directly assigned to the users, permissions linked to the users through groups or profiles mapped to roles, and permissions linked to users through roles mapped to groups or profiles. For instance, through the stub data stored in the database, a user may be linked to a profile or group. The profile or group may be linked to a role. Accordingly, the user may be linked to permissions assigned to the role through the profile or group. Likewise, a user may be linked to a role and the role may be linked to a profile or group. Accordingly, the user may be linked to permissions assigned to the profile or group through the role.

In some embodiments, the analytics engine is operable to receive a request for a multi-system analysis and query the database for a list of complete permissions on a per user basis cross the plurality of enterprise-class systems in the enterprise computing environment. A list of complete permissions for a user may include permissions directly assigned to the user, permissions assigned to the user based on role(s) associated with the user, permissions assigned to the user based on a group(s) or profile(s), permissions linked to the user through the group(s) or profile(s) mapping to a role(s), and permissions linked to the user through a role(s) mapped a group(s) or profile(s).

In some embodiments, the analytics engine is operable to determine applicable system-type-specific rulebooks from the plurality of enterprise-class systems and analyze, in a system-agnostic manner, the list of complete permissions in view of user permissions granted to each user and business functions governed by rules defined in the system-type-specific rulebooks. The analytics engine is also operable to apply the rules specified therein to crosscheck and determine rule-to-permission hits (e.g., users satisfying the business functions governed by the rules, indicating user access risks) across the plurality of enterprise-class systems. Based on the insights from this multi-system analysis (e.g., the rule-to-permission hits), a report can be generated and presented for review through a user interface and/or output to a file.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a diagrammatical representation of an example of an access risk management system having a database-driven analytics engine according to some embodiments disclosed herein.

FIG. 2 depicts an example of a security extract that contains permissions on a per user basis according to some embodiments disclosed herein.

FIG. 3 depicts an example of a rulebook that contains a rule with a logical (Boolean) operator, the rule governing a set of business functions according to some embodiments disclosed herein.

FIG. 4 shows an example of a rule-to-permission object model according to some embodiments disclosed herein.

FIG. 5 illustrates by example how users of an enterprise can be linked to permissions through various paths that can crossover disparate security models utilized by different enterprise-class systems according to some embodiments disclosed herein.

FIG. 6 illustrates an example of a security model in which users can be linked to permissions through various paths, including those involving group and roles, according to some embodiments disclosed herein.

FIG. 7 depicts a flow diagram that illustrates an example of operations performed by an extract processor according to some embodiments disclosed herein.

FIG. 8 depicts a flow diagram that illustrates an example of operations performed by a rulebook compiler according to some embodiments disclosed herein.

FIG. 9 depicts a flow diagram that illustrates an example of operations performed by a hit analyzer according to some embodiments disclosed herein.

FIGS. 10A-10F provide an example of how database tables can be structured for storing different types of permissions according to some embodiments disclosed herein.

FIG. 11A depicts a flow diagram that illustrates an example of an overall data flow according to some embodiments disclosed herein.

FIG. 11B depicts a flow diagram that illustrates an example of a process flow from the engine's perspective according to some embodiments disclosed herein.

FIG. 12 depicts a flow chart that illustrates an example of a method for generating, on a per user basis, a list of permissions across a plurality of different enterprise-class systems in an enterprise computing environment according to some embodiments disclosed herein.

FIG. 13 depicts a flow chart that illustrates an example of a method for processing a request for a multi-system analysis according to some embodiments disclosed herein.

FIGS. 14-16 provide examples of different simulated security models according to some embodiments disclosed herein.

FIG. 17 depicts a diagrammatic representation of a data processing system for implementing an embodiment disclosed herein.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before delving into more detail regarding the specific embodiments disclosed herein, some context may be helpful.

As alluded to above, in an organization, having one person being able to perform multiple related tasks can potentially cause harm to the organization and, therefore, represents a risk to the organization. For example, Joe User can create vendors in an Accounts Payable (AP) system. He can also pay vendors through the same AP system. Since Joe User has the proper permission to access the AP system, nothing prevents him from making a made-up vendor called “Joe Enterprise” and paying this vendor for a seemingly harmless service out of his employer's pocket. While auditors and supervisors can manually check to see if Joe User has the ability to add a vendor and they can also manually check to see if he has the ability to pay a vendor, nothing indicates that they should check to see if Joe User can do both at the same time and, currently, there are no tools that can check to see if he can do both at the same time. Further, there can be hundreds, thousands, or even more employees in a company, simply checking Joe User's permissions is not enough.

What is needed here is the ability to prevent anyone from creating a vendor and paying the vendor at the same time. However, this is a complicated problem to solve as there are many different risky combinations of duties and permissions in an enterprise computing environment. Further, manually tracking and analyzing all these different combinations of duties and permissions can be time-consuming and susceptible to errors.

As discussed above, a custom, one-system-at-a-time approach can be used to identify SoD risks. This prior approach involves creating a custom solution on a per system basis. That is, each custom solution is tightly coupled to a single instance of a business application, making it impossible to analyze multiple systems, which usually have different system types, at the same time.

Further, the custom solution can be very slow due to the inherently single-threaded, memory-intensive, and inefficient technologies involved. Because changing one thing in the custom solution would require changing everything, the custom solution can be characterized as monolithic. The custom solution can also be characterized as unwieldy because it generates a large amount of metadata that is difficult to use.

Moreover, the custom solution is rather inflexible as it makes only one set of report data, with limited means to visualize the data. Because larger systems would take many more resources to accomplish an analysis, the custom solution would scale rather poorly.

A goal of the invention disclosed is to overcome these problems. This goal is realized with a database-driven analytics engine (which is referred to hereinafter as the “engine”). As a non-limiting example, the engine can be implemented as part of an Access Risk Management (ARM) technology platform, available from SailPoint Technologies in Austin, Texas. SailPoint's ARM technology platform is operable to detect when a company might be at risk by checking to see if an employee can perform multiple duties without supervision (e.g., an employee with both “create/change a vendor” and “pay a vendor” duties can create a fictitious vendor and cut a check for the fictitious vendor through different business functions provided by the same system or different systems). As these business functions are part of the employee's normal job activities, and the employee likely processes dozens of such requests a day, such activities would rarely gain attention. SailPoint's ARM technology platform can fill this gap through a permission-based, granular access risk analysis that can identify potential access risks before an access request is granted.

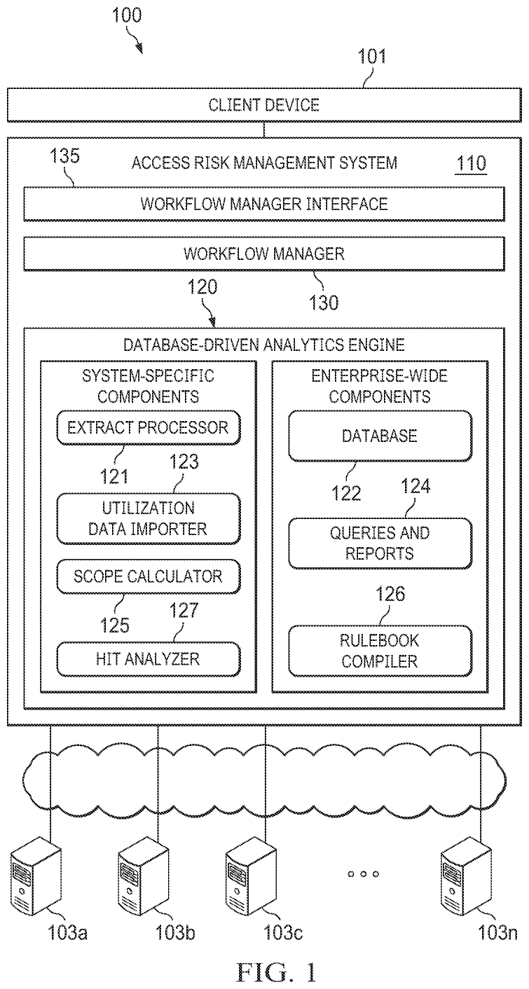

In some embodiments, the engine leverages a standardized structure (e.g., a rules-to-permission object model) that all systems under examination can fit in some way. With a Service-Oriented Architecture (SOA), business-application specific tasks can be separated from a standardized interface. This allows the engine to break data down to its smallest component (e.g., a permission) and rolls it up, one level at a time. In this way, the engine can analyze data across different systems and different system types. The engine is capable of making targeted queries, such as those for what-if scenarios, in real time. Further, the engine can provide results (which are also referred to herein as insights) to a reporting tool for generating reports. In some embodiments, the engine can be part of an access risk management system, an example of which is illustrated in FIG. 1.

As illustrated in FIG. 1, an access risk management (ARM) system 110 (which is referred to hereinafter the “system”) can have a database-driven analytics engine 120 (which is referred to hereinafter as the “engine”), a workflow manager 130, and a workflow manager interface 135. The system 110 is communicatively connected to a client device 101 and a plurality of enterprise-class systems 103a, 103b, 103c, . . . , 103n operating in a distributed and networked enterprise computing environment 100.

In some embodiments, through the workflow manager interface 135, a user of the client device 101 can request for a single-system analysis of access risks with respect to one of the plurality of enterprise-class systems 103a, 103b, 103c, . . . , 103n. Through the workflow manager interface 135, the user can also request for a multi-system analysis of access risks across the plurality of enterprise-class systems 103a, 103b, 103c, . . . , 103n.

In some embodiments, the workflow manager 130 is operable to track the metadata of each access risk analysis request received from the client device 101 and update the status of a corresponding analysis workflow accordingly. Actions performed by the workflow manager 130 and interactions between the workflow manager 130 and various components of the engine 120 are described below.

In the example illustrated in FIG. 1, the engine 120 comprises system-specific components and enterprise-wide components. Examples of system-specific components include an extract processor 121, a utilization data importer 123, a scope calculator 125, and a hit analyzer 127. Examples of enterprise-wide components include a database 122, a queries and reports module 124, and a rulebook complier 126. In some embodiments, the system 110 may operate in a cloud computing environment and these engine components can be implemented as microservices provided by the system 110.

In some embodiments, the extract processor 121, the rulebook compiler 126, and the hit analyzer 127 are operable to populate various tables stored in the database 122. The database used by the engine is referred to herein as an internal database or a central database.

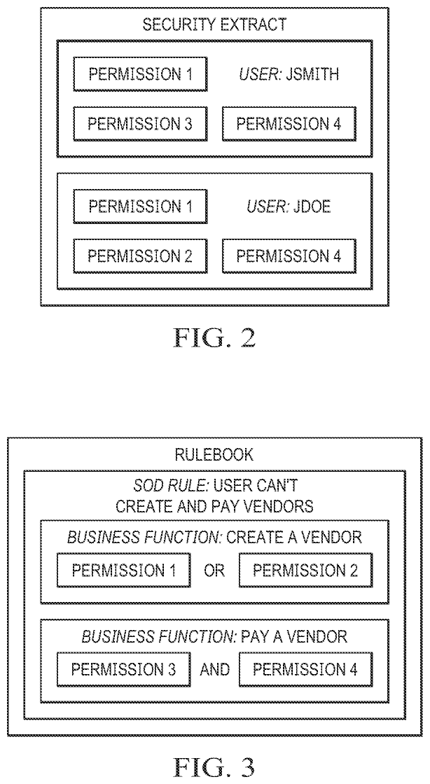

In some embodiments, the extract processor 121 is configured for processing security extracts. FIG. 2 depicts an example of a security extract that contains permissions on a per user basis (e.g., permissions for User J Smith and permissions for User J Doe).

Referring back to FIG. 1, in some embodiments, the rulebook compiler 126 is configured for compiling rulebooks. FIG. 3 depicts an example of a rulebook that contains a sample SoD rule (e.g., a user cannot both create and pay vendors) that applies to multiple business functions, including a business function of creating a vendor and a business function of paying a vendor. In this example, the business function of creating a vendor has an OR logic (with a logical operator “OR”) that can be satisfied by Permission 1 or Permission 2, while the business function of paying a vendor has an AND logic (with a logical operator “AND”) that requires both Permission 3 and Permission 4. Accordingly, a user with Permission 1 or Permission 2 can perform the business function of creating a vendor and a user with Permission 3 and Permission 4 can perform the business function of paying a vendor.

In the example of FIG. 2, User J Smith has Permission 1, Permission 3, and Permission 4 and User J Doe has Permission 1, Permission 2, and Permission 4. Thus, both User J Smith and J Doe are permitted to perform the business function of creating a vendor. Additionally, User J Smith has Permission 3 and Permission 4, so User J Smith is permitted to perform the business function of paying a vendor. That is, in this example, User J Smith is permitted to perform multiple business function that allows both the creation of a vendor and payment to a vendor at the same time.

In the example of FIG. 3, the SoD rule specifies that a user cannot create and also pay vendors. Suppose the business function of creating a vendor is part of the enterprise-class system 103a (e.g., an ERP system) and further suppose that the business function of paying a vendor is part of the enterprise-class system 103b (e.g., an accounting system), it can be practically impossible for custom solutions built on a per-system basis to efficiently, correctly, and timely identify User J Smith as a candidate for a possible SoD risk. It might be possible to conduct two single-system analyses of access risks with respect to the enterprise-class system 103a and the enterprise-class system 103b and then manually compare the results from both single-system analyses. However, as alluded to above, these enterprise-class systems are organized and managed in completely different ways. The disparate nature of these enterprise-class systems made identifying distributed risks across these systems a highly manual, inefficient, and incomplete process. Therefore, even with a manual review, it can be very difficult to identify User J Smith as a candidate for a possible SoD risk that applies to both enterprise-class systems.

To provide the system 110 with the ability to quickly identify such risks across the plurality of enterprise-class systems 103a . . . 103n, the engine 120 is operable to break data from the plurality of enterprise-class systems 103a . . . 103n down to the permission level and then roll the permissions up, one level at a time, according to a “system-agnostic” rule-to-permission object model.

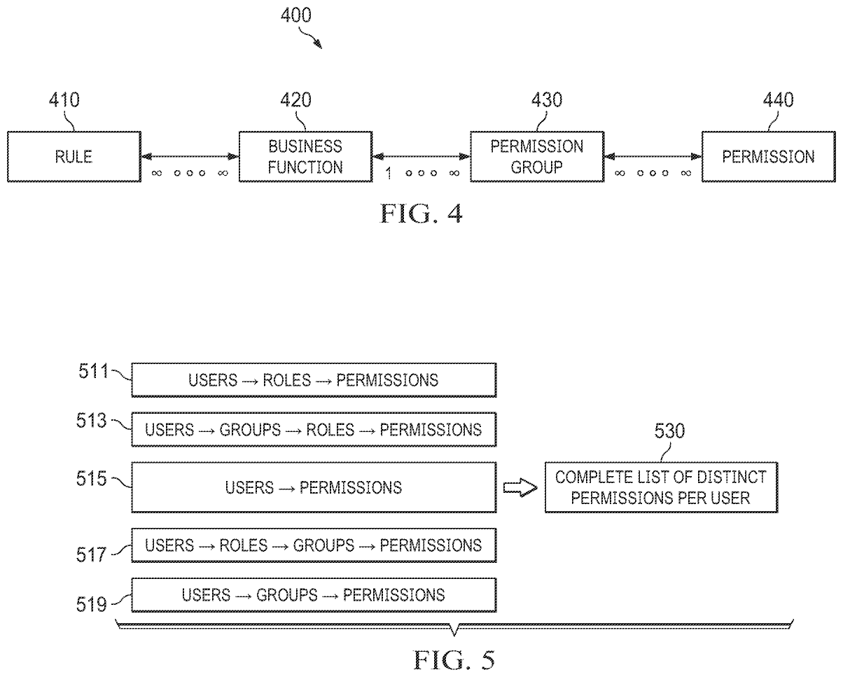

FIG. 4 shows an example of a rule-to-permission object model 400 (which is referred to hereinafter as the “object model”) that defines a standardized structure for managing access permissions in a more granular way. As illustrated in FIG. 4, there can be 1 . . . n rules 410 for 1 . . . n business functions 420. Each business function can have 1 . . . n permission groups 430 which, in turn, can have 1 . . . n permissions 440. In the object model 400, the smallest component is a permission. These rules, business functions, and permissions, which are represented in the object model 400 at an abstraction layer above the plurality of enterprise-class systems 103a . . . 103n, are agnostic to, and not confined by, the structures of the plurality of enterprise-class systems 103a . . . 103n.

This object model allows the engine to query the database at the user permission level, the group permission level, the business function level, and the rule (risk) level. In some embodiments, the engine can query the database to find satisfied rules as described below. A rule is considered satisfied when all assigned business functions for the rule for a user are satisfied. Following the above example, a query for rule-to-permission hits against the database would return User J Smith as a potential SoD risk because User J Smith satisfies the business functions governed by the SoD rule shown in FIG. 3.

As illustrated in FIG. 5, linking users of the plurality of enterprise-class systems 103a . . . 103n to permissions granted to them by the plurality of enterprise-class systems 103a . . . 103n can take a plurality of paths 511, 515, 519. The plurality of paths can crossover different security models utilized by the plurality of enterprise-class systems 103a . . . 103n. For example, some enterprise-class systems may assign permissions directly to users (515), some may assign permissions to roles (511), and some may assign permissions to groups or profiles (519). Generally, it is not possible to programmatically crosscheck the profiles and roles with groups assigned or otherwise associated with the same users who are permitted to access yet another system that employs a group-based security model.

By breaking data from the plurality of enterprise-class systems 103a . . . 103n down to the smallest components and then rolling back up, one level at a time, embodiments disclosed herein can link users to permissions through groups (e.g., user groups) mapped to roles (513) as well as roles mapped to groups (517). This results in a complete list of distinct permissions per user 530.

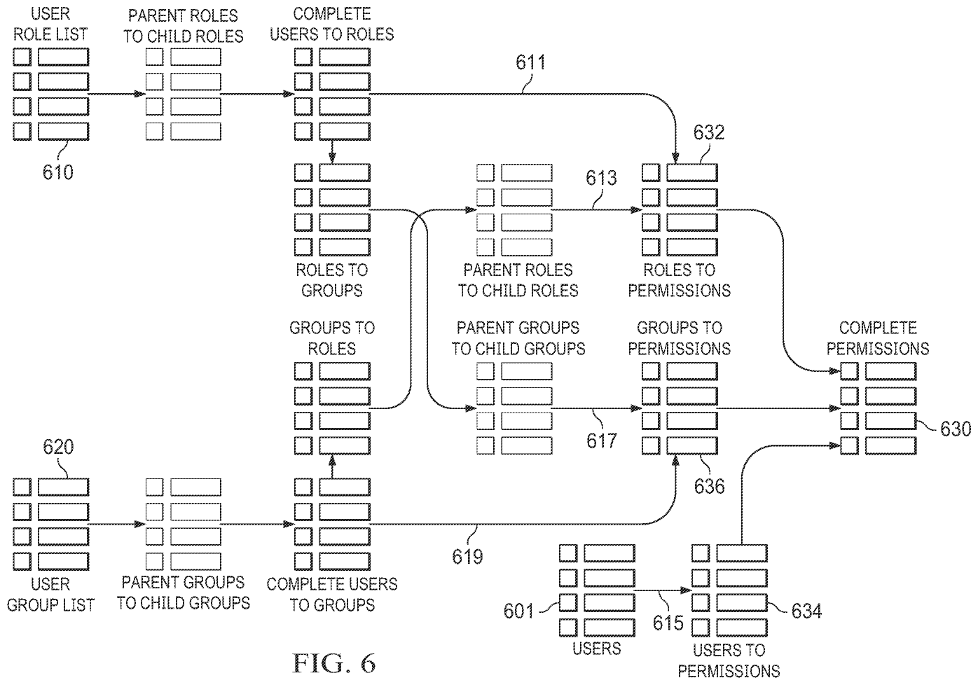

FIG. 6 illustrates an example of a security model in which users can be linked to permissions through various paths, including those involving group and roles. As illustrated in FIG. 6, there can be many possible paths for linking users 601 of an enterprise through respective security principals (e.g., users, roles, groups, etc.) to permissions 630.

In this example, users 601 may be permitted to access a first system per a user role list 610 and access a second system per a user group list 620. The first system and the second systems can be of different system types that employ different security models. In the security model of the first system, user permissions are role-based. In the security model of the second system, user permissions are group-based.

Traditionally, linking users with role-based permissions (e.g., Roles to Permissions 632) may take the path that checks, on a per user basis, role(s) associated with or otherwise assigned to a user, roles to add and/or remove, parent roles to child roles, etc. (611). Further, traditionally, linking users with group-based permissions (e.g., Groups to Permissions 636) may take the path that checks, on a per user basis, group(s) associated with or otherwise assigned to a user, groups to add and/or remove, parent groups to child groups, etc. (619). For permissions directly assigned to a user, linking the user with those permissions can take the direct path to Users to Permissions 634 (615).

As discussed above, ordinarily, it is not possible to perform crossover checks on roles to groups or groups to roles. However, because the stub data stored in the database represents extracted and/or derived metadata such as users, roles, groups, assets, users-to-roles, roles-to-groups, and groups-to-users, the engine can query the database and perform crossover checks on Groups to Roles (613) as well as Roles to Groups (617).

In some cases, these checks can involve traversing one or more role and/or group hierarchies for permissions assigned to parent roles and/or groups that contain one or more permissions themselves. For example, a permission may be assigned to a role “A”, and role A has a role “B” assigned to it as well. Role B might, in turn, have a role “C” assigned to it. If a user were assigned to role C, they would inherit the assigned permissions for roles A and B as well as role C. However, a user assigned to role A would only have access to the permissions associated with Role A.

As a non-limiting example, suppose
Role A may contain:
   Permission 1
   Permission 2
   Role B (i.e., Role A is the parent of Role B)
Role B may contain:
   Permission 3
   Role C (i.e., Role B is the parent of Role C)
Role C may contain:
   Permission 4

Then, a user assigned to Role C would have access to Permissions 1, 2, 3, and 4.

A user assigned to Role B would have access to Permissions 1, 2, and 3.

A user assigned to Role A would only have access to Permissions 1 and 2.

The same relationship structure illustrated above may exist for groups as well.

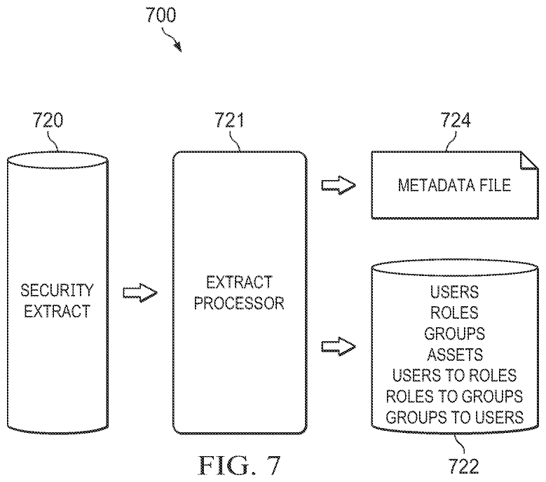

By relating user group(s) to user role(s) and vice versa, more permissions can be captured in the Roles to Permissions table 632 and the Groups to Permissions 636 table, allowing the engine to obtain a list of complete permissions 630 on a per user basis. The database is populated with outputs from various components of the engine such as the extract processor 121, the rulebook compiler 126, and the hit analyzer 127 shown in FIG. 1. Operations of these engine components are discussed below with reference to FIG. 7-12.

In some embodiments, the extract processor is configured for transforming a system-specific security extract into a standardized format and generating a security extract metadata file with enough information and context for streaming analytics, and placing the metadata file in a cloud storage. In some embodiments, this transformation entails breaking down the security data into the smallest components, permissions, and rolling them up, one level at a time, for instance, grouping permissions per user, grouping user permissions per role, creating permission groups and defining business functions in a rulebook, etc. This standardized structure allows the engine to examine disparate systems and treat them as one system for a SoD analysis.

In some embodiments, the extract processor is further configured for saving “stub” data to a database internal to the engine, identifying security principals (e.g., users, roles, and/or groups that are allowed to do certain things), and identifying assets (e.g., who/what can be acted upon). In computing, a stub refers to a small program routine that substitutes for a longer program, possibly to be loaded later or that is located remotely. Here, the stub data is used in place of the actual metadata contained in the security extract metadata file, which is stored elsewhere (e.g., in the cloud storage).

FIG. 7 depicts a diagrammatical representation of an example operation 700 performed by an extract processor 721, which is a system-specific component of an engine (e.g., the engine 120 shown in FIG. 1). In the example illustrated in FIG. 7, the extract processor 721 obtains a system-specific security extract from a security extract database 720. The security extract database 720 may store system-specific security extracts from multiple enterprise-class systems having disparate system types. The extract processor 721 is operable to transform the system-specific security extract into a standardized format and generates a security extract metadata file 724 containing extracted and/or derived metadata describing users, roles, groups, assets, users-to-roles, roles-to-groups, and groups-to-users. The extract processor 721 is further operable to save the security extract metadata file 724 in a cloud storage and save the stub data in a database 722 internal to the engine (e.g., the database 122 shown in FIG. 1).

In some embodiments, the security extract metadata file can include system-type-specific breakdowns of security principals (e.g., users, roles, groups, etc.) to permissions. Different systems may have different ways in how permissions are handled. For example, suppose an ERP system associates permissions with a user profile. The transformation may treat the user profile as a grouping mechanism for associating permissions. In this way, a security extract metadata file thus generated may contain profile objects and explicit permissions assigned to these profile objects. This breakdown is specific to the ERP system (and any system of the same type in which permissions are associated with a profile). As another example, suppose a human resources (HR) system assigns permissions to roles. A security extract metadata file thus generated would include system-type-specific breakdowns of permissions assigned to roles. Other ERP systems, HR systems, etc., will have permissions assigned and maintained in different ways.

In some embodiments, the rulebook compiler is configured for identifying, from a rulebook, the “stub” data for permissions, permission groups, business functions, and risks, identifying mitigations and rules for applying the mitigations to the risks, saving the stub data to the internal database, generating a metadata file for use by a hit analysis, and saving the metadata file to a cloud storage. In some embodiments, the rulebook compiler generates one permission-containing metadata file per a rulebook per a supported system type (which is referred to herein as the “permissions metadata file”).

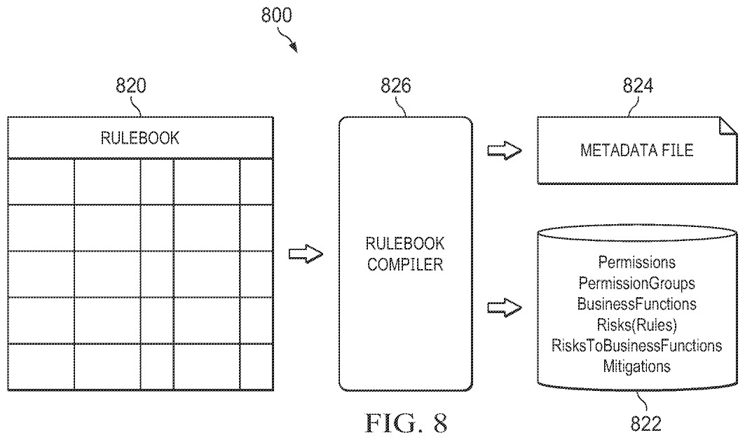

FIG. 8 depicts a diagrammatical representation of an example operation 800 performed by a rulebook compiler 826. In the example illustrated in FIG. 8, the rulebook compiler 826 obtains a rulebook 820 (e.g., from a rulebook database). The rulebook compiler 826 is operable to identify, from the rulebook 820, stub data for the permissions, permission groups, business functions, and risks (rules). In some embodiments, the rulebook compiler 826 is also operable to identify mitigations and rules for applying the mitigations to the risks.

The rulebook compiler 826 generates a permissions metadata file 824 that contains the metadata identified through this operation and saves the permissions metadata file 824 to the cloud storage. The stub data is saved to the internal database (822). The permissions metadata file 824 can be used by a hit analyzer (e.g., the hit analyzer 127) as discussed below.

In some embodiments, the hit analyzer, which is system-type-specific, requires a valid, compiled rulebook (e.g., a system-type-specific output from the rulebook compiler which includes a permissions metadata file containing permissions, permission groups, business functions, risks (rules), etc.) and a valid, processed security extract (e.g., a system-specific output from a corresponding system-specific extract processor which includes a security extract metadata file containing permissions per user, permissions per role, permissions per group, etc.).

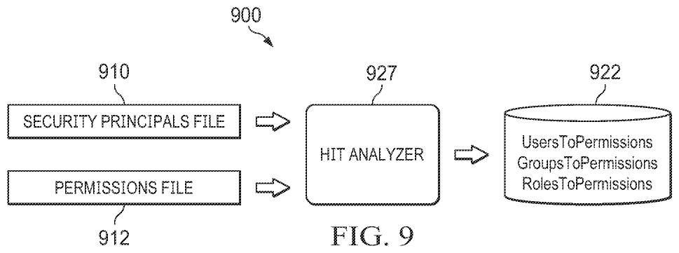

FIG. 9 depicts a diagrammatical representation of an example hit analysis operation 900 performed by a hit analyzer 927. In the example illustrated in FIG. 9, the hit analyzer 927 is operable to load a permissions metadata file 912 (e.g., from a valid, compiled rulebook), stream through a security extract metadata file 910 (e.g., from a valid, processed security extract), and examine the security principals (e.g., users, roles, groups, etc.) to determine if any match is found against the permissions. Upon a match being found, the hit analyzer 927 is operable to record this information as a “hit” (e.g., a User-to-Permission hit, a Group-to-Permission hit, a Role-to-Permission hit, etc.) in a database 922 (e.g., the database 122 shown in FIG. 1).

In some embodiments, the functionality of the hit analyzer can be scaled horizontally by splitting up permissions and/or security principals (e.g., users, roles, groups, etc.). In some cases, the security principals can be a smaller collection.

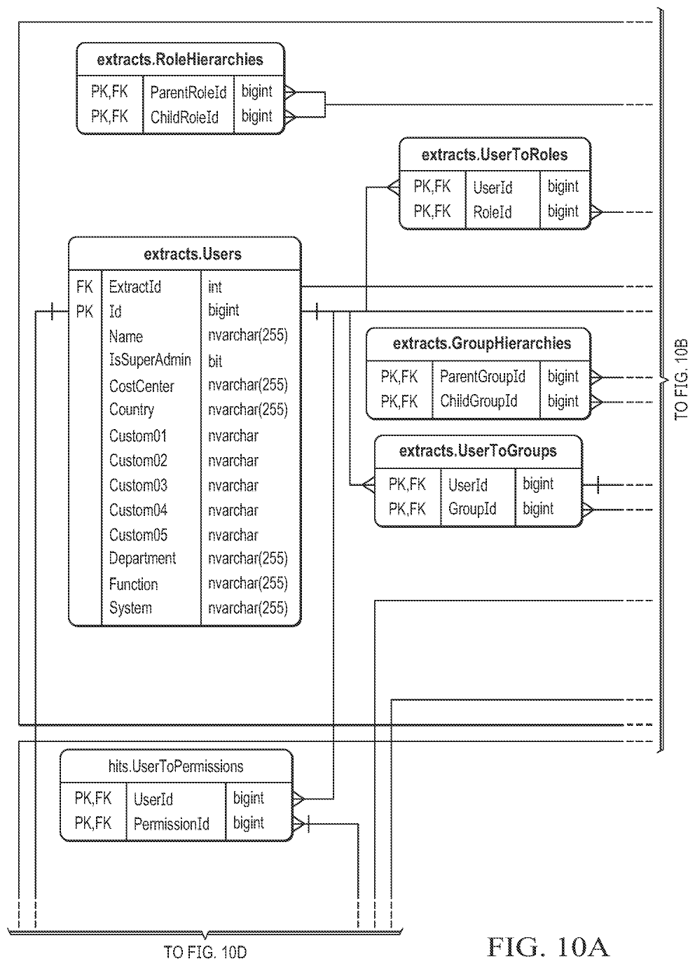

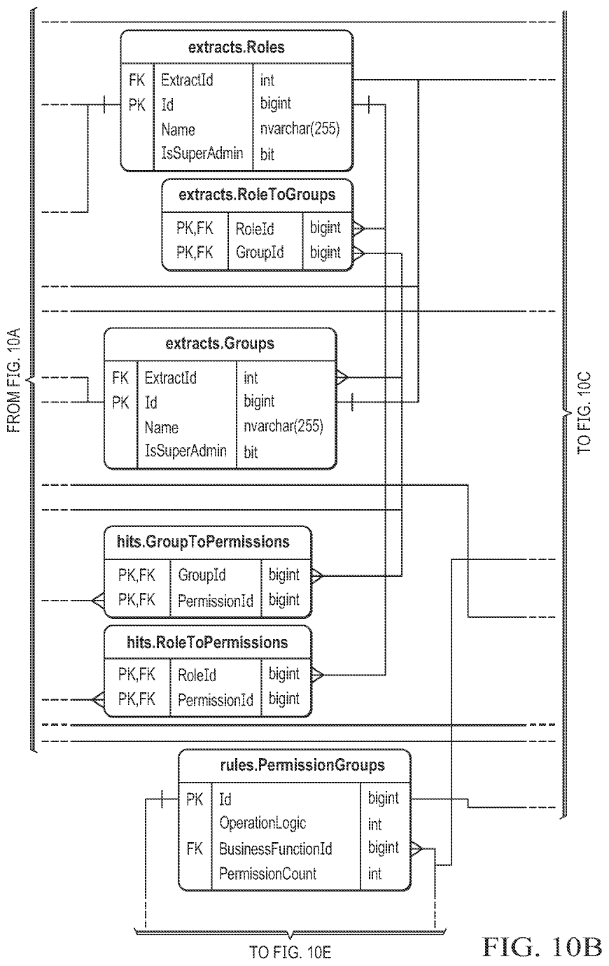

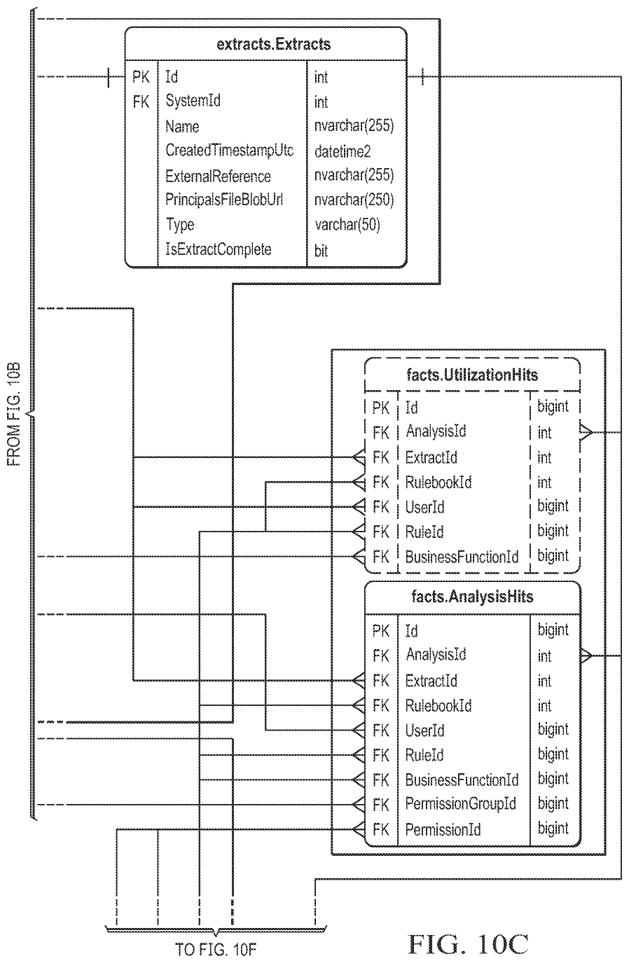

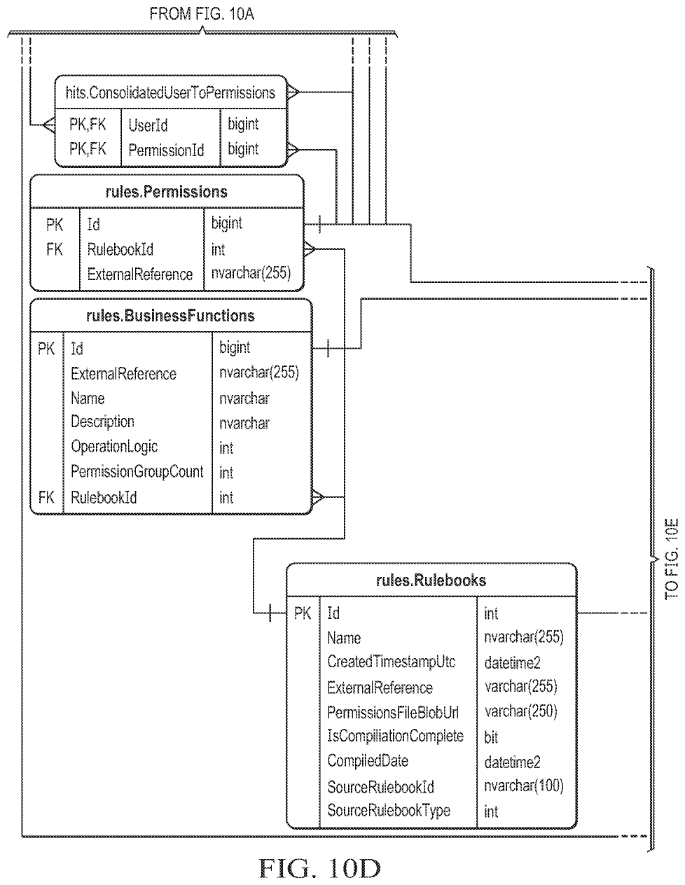

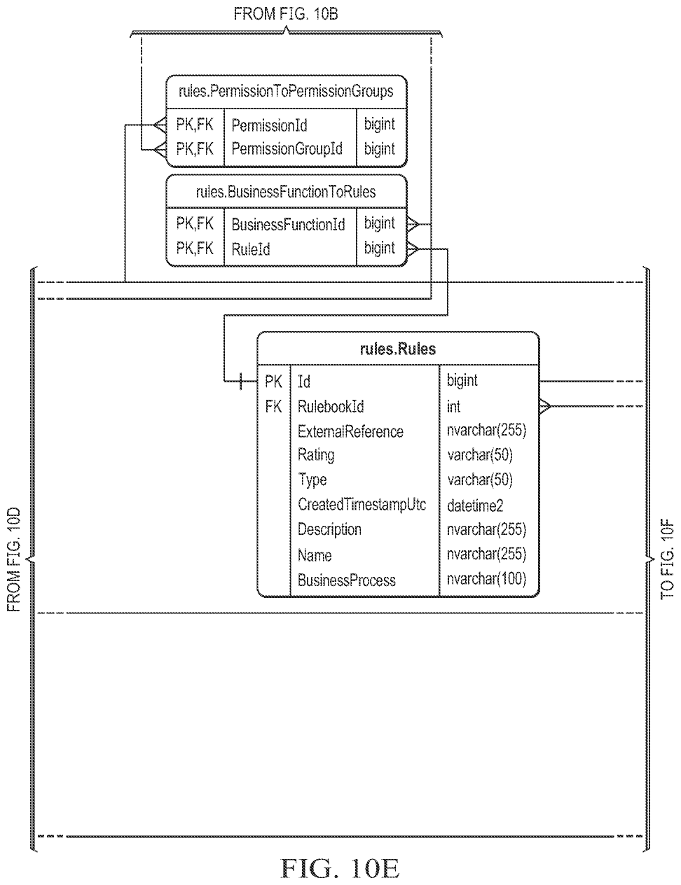

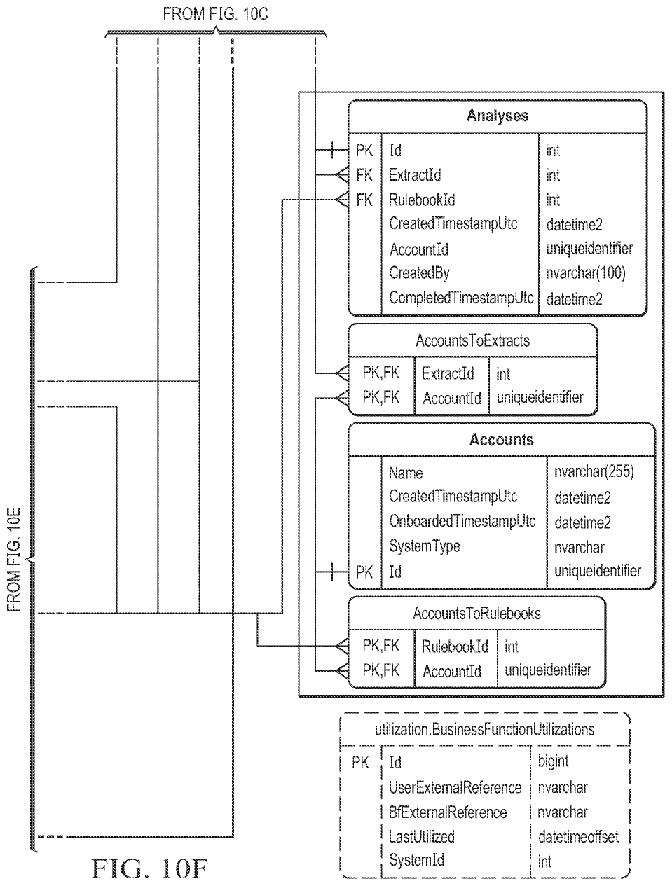

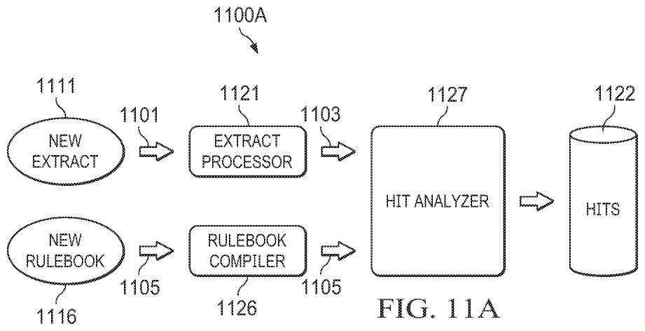

In some embodiments, the database 922 may comprise one of the following tables per system type: a Users-to-Permissions table, a Groups-to-Permissions table, or a Roles-to-Permissions table. These tables store the stub data for use by the engine. FIGS. 10A-10F provide an example of how the tables can be structured to conform to the rule-to-permission object model. In some embodiments, the actual data can be stored in a relational database management system (e.g., a Structured Query Language (SQL) database residing on a database server). The database server can be hosted in the cloud, providing a cloud storage for the actual data.

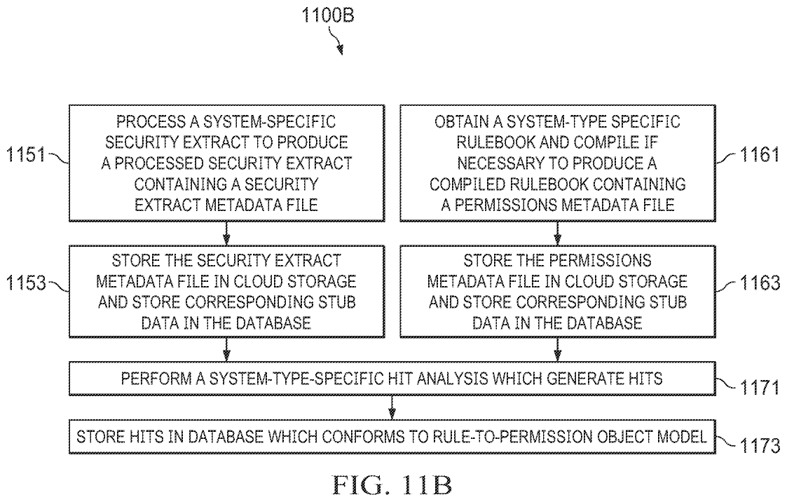

FIG. 11A depicts a flow diagram that illustrates an example of an overall data flow according to some embodiments. As a non-limiting example, engine operations are performed over a service bus.

In some embodiments, an extract processor 1121 may receive a service bus message indicating that a new supported security extract 1111 is available for processing (1101). The extract processor 1121 is operable to process the new security extract 1111 as discussed above and sends out a service bus message indicating that the extract processing is complete (1103).

In some embodiments, a rulebook compiler 1126 may receive a service bus message that a new rulebook 1116 is available for processing (1105). The rulebook compiler 1126 is operable to compile the new rulebook 1116 if necessary and sends out a service bus message indicating that the rulebook compilation is complete (1107).

As discussed above, performing a hit analysis requires a valid, complied rulebook and a valid, processed security extract. As illustrated in FIG. 11A, a hit analyzer 1127 (which is specific to a system type) may receive a valid, processed security extract from the extract processor 1121 (which is specific to a system of the system type) and a valid, complied rulebook (which is specific to the system type) from the rulebook compiler 1126. The valid, processed security extract includes a security extract metadata file and the valid, complied rulebook includes a permissions metadata file. The hit analyzer 1127 is operable to load the permissions metadata file, analyze the permissions groups, business functions, and rule(s) against the security principals and associated permissions indicated by the metadata contained in the security extract metadata file, determine if any match is found (i.e., a “hit”), generate satisfied hits, and stores the satisfied hits in a database 1122. The database 1122 can be an enterprise-wide engine component (e.g., the database 122 shown in FIG. 1).

FIG. 11B depicts a flow diagram that illustrates an example of a process flow 1100B from the engine's perspective according to some embodiments. In this example, a system-specific component of the engine (e.g., the extract processor 121 shown in FIG. 1) is operable to process a system-specific security extract to produce a valid, processed security extract containing permissions on a per user basis (1151). This operation produces a security extract metadata file and corresponding stub data. The security extract metadata file contains metadata describing the security principals (e.g., users, roles, groups, etc.) and associated permissions. The engine stores the security extract metadata file in a cloud storage and the corresponding stub data in a database (e.g., the database 122 shown in FIG. 1) (1153).

Concurrently or separately, an enterprise-wide component of the engine (e.g., the rulebook compiler 126 shown in FIG. 1) is operable to obtain a system-type-specific rulebook and compile if necessary to produce a valid, compiled rulebook (1161). The rulebook contains a rule that applies to multiple business functions, each of which requires a set of permissions that satisfies a Boolean logic. This operation produces a permissions metadata file and corresponding stub data. The permissions metadata file contains metadata that describes the rule, the business functions, permission sets (or groups), etc. The engine stores the permissions metadata file in a cloud storage and the corresponding stub data in a database (e.g., the database 122 shown in FIG. 1) (1163).

Once the valid, processed security extract and the valid, compiled rulebook are ready, a system-type-specific component of the engine (e.g., the hit analyzer 127 shown in FIG. 1) is operable to perform a hit analysis as discussed above and generate satisfied hits (e.g., User-to-Permission hits, Group-to-Permission hits, Role-to-Permission hits, etc.) (1171). The engine then stores the hits in the database (1173).

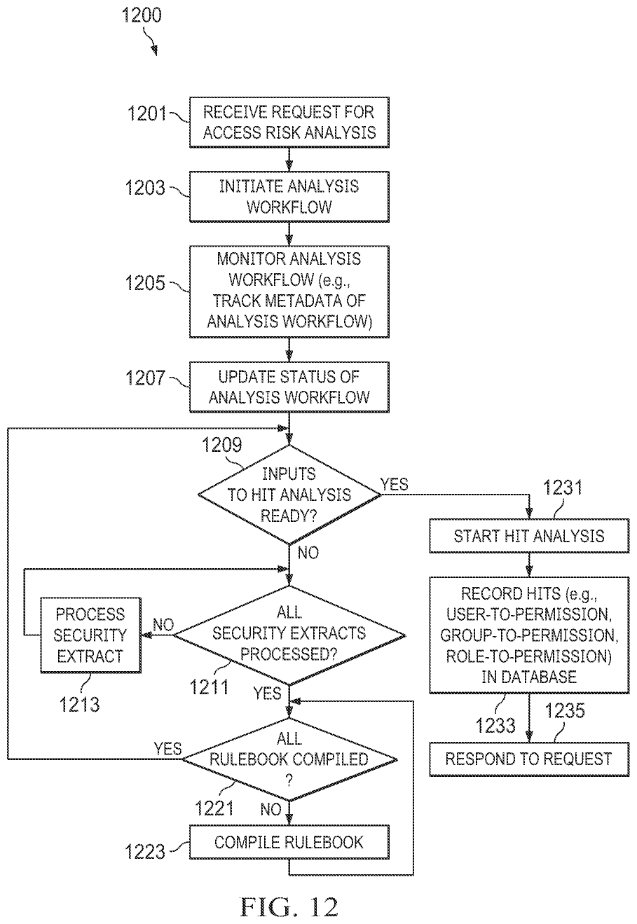

FIG. 12 depicts a flow chart that illustrates an example of a method 1200 for generating, on a per user basis, a list of permissions across a plurality of different enterprise-class systems in an enterprise computing environment. In some embodiments, the method 1200 may be triggered by a request for a multi-system analysis, initiated on demand (e.g., by an authorized user such as an administrator), conducted periodically (e.g., to make sure that the list of permissions is always up to date), or as configured (e.g., when a new enterprise-class system is instantiated, when a system-specific security model is updated, etc.).

As a non-limiting example, a workflow manager (e.g., the workflow manager 130 shown in FIG. 1) may receive a request for access risk analysis from a client device (e.g., the client device 101) (1201). The request may involve a single system access risk analysis or a multi-system access risk analysis.

In some embodiments, the workflow manager is operable to initiate an analysis workflow for an engine (e.g., the analytics engine 120) to process the request (1203) and monitor the status of the analysis workflow (1205). This monitoring can include tracking the metadata related to the analysis workflow. The workflow manager is operable to update the status of the analysis workflow accordingly (1207).

In some embodiments, the workflow manager is further operable to check and determine whether all the necessary components for the analysis workflow are ready (1209). For example, if a security extract has not been processed (1211), the workflow manager can publish an instruction message to a system-specific component of the engine (e.g., the extract processor 121 shown in FIG. 1) to process the security extract (1213).

As a non-limiting example, this can be done by sending a “start” message (e.g., “ProcessSapExtract,” “ProcesSfExtract,” “ProcesUConnectExtract,” etc.) to a queue. The corresponding system-specific extract processor (e.g., “SapExtractProcessor,” “SfExtractProcessor,” “UConnectExtractProcessor,” etc.) monitors or listens to the queue and operates to process the security extract per the “start” message published to the queue. Once the extraction is complete, the system-specific extract processor returns a “complete” message (e.g., “SapExtractProcessed,” “SfExtractProcessed,” “UConnectExtractProcessed,” etc.) to the workflow manager.

As another example, if a rulebook has not been compiled (1221), the workflow manager can publish (e.g., via a queue) an instruction message to an enterprise-wide component of the engine (e.g., the rulebook compiler 126 shown in FIG. 1) to compile the rulebook (1223). In some embodiments, this can be done by sending a “compile” message (e.g., “CompileMsrb”) to a queue. The rulebook compiler monitors or listens to the queue and operates to compile the rulebook per the “compile” message published to the queue. Once the rulebook compilation is complete, the rulebook compiler returns a “complete” message (e.g., MsrbCompiled) to the workflow manager.

In some embodiments, if a multi-system access risk analysis is involved (1201), individual analysis workflows are initiated (1203) and monitored on a per system basis (1205). This monitoring can include continuously monitoring individual analysis workflows and tracking the metadata related to the individual analysis workflows. The workflow manager is operable to update the status of each analysis workflow accordingly (1207) and determine whether all the necessary components for a system-specific hit analysis are ready (1209). For example, the workflow manager may determine that certain security extracts are not available in a particular system (1211) and may publish an instruction message to an extract processor (e.g., via a queuing mechanism) to process those security extracts (1213). The extract processor operates to process the security extracts as instructed and returns a “complete” message to the workflow manager as discussed above. The workflow manager may also determine that a rulebook has not been compiled (1221) and may publish an instruction message to the rulebook compiler (e.g., via a queue) to compile the rulebook (1223). The rulebook compiler operates to compile the rulebook as instructed. Once the rulebook compilation is complete, the rulebook compiler returns a “complete” message to the workflow manager as discussed above. These operations can be performed concurrently and/or in no particular order.

If the workflow manager determines that all the necessary input components for a particular hit analysis are ready, the workflow manager can initiate a system-specific hit analyzer (e.g., the hit analyzer 127, which can be specific to one of the disparate enterprise-class systems 103a, 103b, 103c, . . . , 103n shown in FIG. 1) (1231). This can be done by sending an “analysis start” message to a corresponding system-specific hit analyzer (e.g., sending an “analysis start” message “AnalyzeSapHits” to a system-specific hit analyzer called “SapHitAnalyzer,” sending an “analysis start” message “AnalyzesSfHits” to a system-specific hit analyzer called “SfHitAnalyzer,” and so on). If an analysis workflow already has hits, no message is sent.

As discussed above, the hit analyzer requires a valid, processed security extract and a valid, compiled rulebook. Each of the extract processor and rulebook compiler discussed above is operable to generate a metadata file that contains the metadata identified through a respective operation (e.g., a security extraction, a rulebook compilation, etc.) and saves the metadata file to the cloud storage and corresponding stub data for the metadata to a database local to the engine (e.g., the database 122 shown in FIG. 1). The hit analyzer is operable to load the metadata file containing permissions from the valid, compiled rulebook, stream through the metadata file containing security principals (e.g., users, roles, groups, etc.) from the valid, processed security extract, and examine the security principals to determine if any match is found against the permissions. Upon a match being found, the hit analyzer is operable to record this information as a “hit” (e.g., a User-to-Permission hit, a Group-to-Permission hit, a Role-to-Permission hit, etc.) in the database (1233).

In some embodiments, once a corresponding hit analysis is done, the system-specific hit analyzer returns an “analysis complete” message to the workflow manager (e.g., the system-specific hit analyzer “SapHitAnalyzer” returning an “analysis complete” message “SapHitsAnalyzed,” the system-specific hit analyzer “SfHitAnalyzer” returning an “analysis complete” message “SfHitsAnalyzed,” and so on). The workflow manager is operable to track the completion of individual hit analyses and update the statuses of all workflows related to each hit analysis.

If all the hit analysis tasks for a hit analysis have completed, the workflow manager is operable to dispatch a finalization process (e.g., by sending an “analysis finalization” message (e.g., “FinalizeAnalysis”) to an analysis completion service which returns an “analysis completion” message (e.g., “AnalysisComplete”). The workflow manager, in turn, updates the status to reflect the “analysis completion” message. Otherwise (i.e., not all tasks have been completed), the workflow manager continues to monitor and track the workflow statuses. After the hit analyses have been conducted, a response to the multi-system analysis request is then returned to the requester (1235).

As discussed above, a hit analyzer is operable to load a permissions metadata file, stream through a security extract metadata file, and examine the security principals (e.g., users, roles, groups, etc.) to determine if any match is found against the permissions. Different system types leverage different security models. Thus, how a match (i.e., a “hit”) is found can depend on the specific security model utilized by the underlying system to which the hit analyzer is configured for conducting the hit analysis.

For instance, if a system having a first system type utilizes a role-based security model, then a path to link a user with role-based permissions may involve checking role(s) associated with or otherwise assigned to the user. If another system of a second system type utilizes a group-based security model, then a path to link the same user to group-based permissions might involve checking group(s) associated with or otherwise assigned to the user. Because these systems are of different system types, it is not possible to programmatically crosscheck groups and roles associated with the same user across these different systems.

In some embodiments, once the stub data are generated and stored (e.g., by the extract processor 121 and the hit analyzer 127 shown in FIG. 1) in the database, the engine can query the database (which conforms to the rule-to-permission object model discussed above) to find satisfied business functions as follows. Logic for business functions per user is the same as permission groups per user. Business functions are defined in the rulebook discussed above. Business functions also have AND/OR logic, except that permission groups (that satisfy a local operator such as an “AND” or “OR”) are counted instead of permissions. A satisfied business function is called a “business function hit.” Returning to FIGS. 2 and 3, suppose the business function of creating a vendor requires Permission 1 or Permission 2. Further suppose that both User J Smith and User J Doe in the example of FIG. 2 are in a permission group based on Permission 1 and User J Doe is also in a permission group based on Permission 2. Both permission groups satisfy this business function and would be counted as hits.

In some embodiments, the engine can query the database to find satisfied permission groups as follows. Permission groups are created by the rulebook compiler discussed above. Permission groups have AND/OR logic and a count of distinct permissions that belong to them. For instance, if a query requires satisfying a Boolean operator “AND” with 10 permissions, all 10 permissions must be present in the list of permission hits per user in order to return a result (i.e., a satisfied permission group). If the logical (Boolean) operator is OR, then any permission hits in the permission group satisfy the requirements for a permission group. A satisfied permission group is called a “permission group hit.”

As discussed above, while security extractions are performed on system-specific security extracts by system-specific extract processors, these system-specific extract processors are operable to transform system-specific security extracts into a standard format, generate extract security metadata files, and store stub data in place of the metadata in a database. Likewise, while hit analyses are performed by system-type-specific hit analyzers, these system-type-specific hit analyzers generate and store hits (e.g., users-to-permissions, groups-to-permissions, roles-to-permissions, etc.) in the standard format in the database. The same database stores the stub data for the permissions, permission groups, business functions, risks (rules), and so on from each system-type-specific rulebook. In this way, the database is populated with a complete list of permissions, with system-specific data (e.g., security extracts, security principals, etc.) broken down into non-system-specific users, roles, groups, etc. at the permission level, allowing mapping of users-to-permissions, groups-to-permissions, roles-to-permissions, role-permissions-to-group-permissions, group-permissions-to-role-permissions, and so on in a system-agnostic manner.

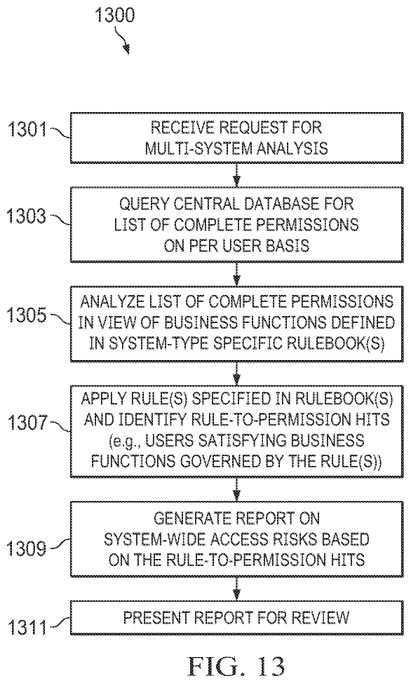

In some embodiments, an access risk management system can implement the method discussed above and provide a user interface for reviewing and managing the permissions across the different systems, which multiple homogeneous business applications or instances of the same system type, multiple heterogenous business applications or instances of different system types) as one system so that the SoD analysis can detect potential access risks across these different systems. An example of a process 1300 is illustrated in FIG. 13.

As discussed above, the engine can query the database to get all the permissions on a per user basis. That is, the engine is operable to generate a complete set of permissions for every user in the enterprise, on a user by user basis. The hits returned by the database can be viewed or otherwise visualized through a user interface and/or stored.

Accordingly, in some embodiments, a system implementing the process 1300 may receive a request for a multi-system analysis (1301) and, in response, prepare and send a query to a central database for a list of complete permissions on a per user basis (1303). As discussed above, the list of complete permissions contains permissions extracted and/or derived from various security models utilized by different enterprise-class systems. The system is operable to determine applicable system-type-specific rulebooks from the different enterprise-class systems and analyze the list of complete permissions in view of user permissions granted to each user and business functions governed by rules defined in the system-type-specific rulebooks in a system-agnostic manner (1305). The system is also operable to apply the rules specified therein to crosscheck and determine rule-to-permission hits (e.g., users satisfying business functions governed by the rules, indicating user access risks) across the different enterprise-class systems (1307). Based on the insights from this multi-system analysis, the system can generate a report on system-wide access risks (1309) and present the report for review through a user interface (1311).

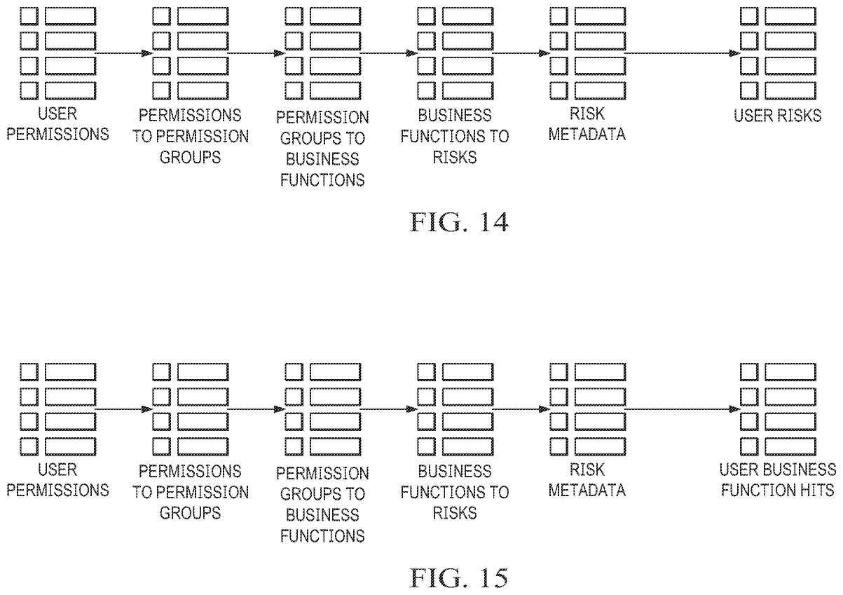

Since the engine operates at an abstraction layer above the different systems under examination, the engine can simulate, through simulation modeling without affecting the underlying systems, different paths in how a particular user maybe associated with a particular permission. FIGS. 14-16 provide examples of different simulated security models.

The simulated security model shown in FIG. 14 is for determining user risks based on user permissions linked to permission groups mapped to business functions and, from the business functions, to rules (risks). The risk metadata thus determined can be used to gain insights on user risks.

The simulated security model shown in FIG. 15 is for determining user business function hits based on user permissions linked to permission groups mapped to business functions and then, from the business functions, to rules (risks). The risk metadata thus determined can be used to gain insights on user business functions that might be risky.

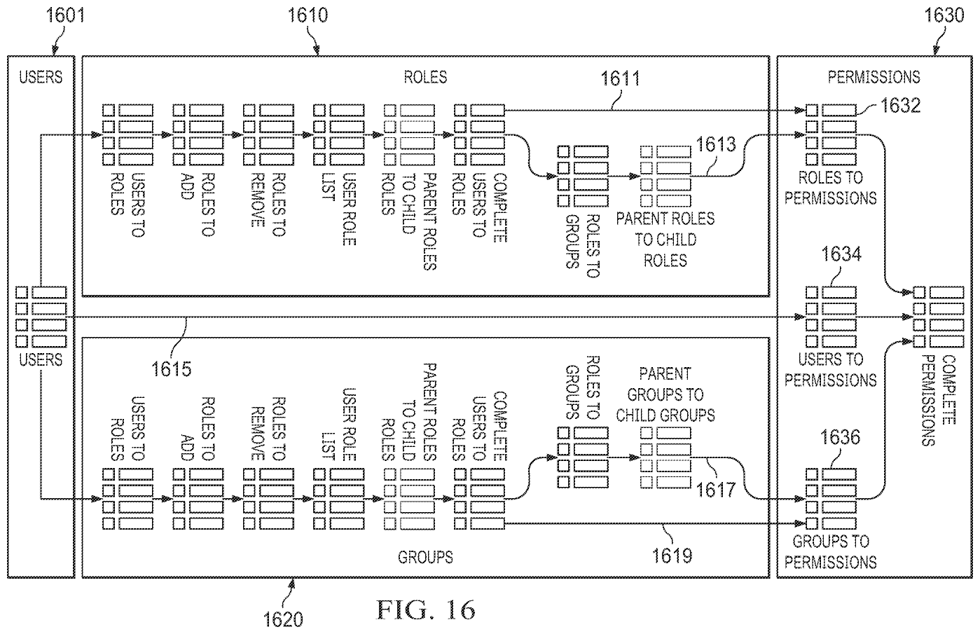

The simulated security model shown in FIG. 16 provides paths similar to those shown in FIG. 6. In this example, users 1601 of an enterprise may have access to different enterprise-class systems 1610 and 1620. Specifically, users 1601 may be permitted to access the enterprise-class system 1610 based on roles and also permitted to access the enterprise-class system 1620 based on permission groups. The enterprise-class system 1610 employs a role-based security model, while the enterprise-class system 1620 employs a group-based security model.

Because the stub data stored in the database represents extracted and/or derived metadata such as users, roles, groups, assets, users-to-roles, roles-to-groups, and groups-to-users, user roles can be related or otherwise mapped to user groups, and vice versa. The same or similar mappings can be done between roles and profiles (e.g., roles mapped to profiles and/or profiles mapped to roles) where profiles are used.

In this way, user permissions can be linked and captured in the Roles to Permissions table 1632 and the Groups to Permissions 1636 table through various paths 1611, 1613, 1617, and 1619, in addition to direct permissions assigned to the users stored in the Users to Permissions table 1634. These simulations allow the engine to determine, from the list of complete permissions 1630, user-to-role-to-permissions, user-to-group-to-permissions, user-to-role-to-parent-role-to-permissions, user-to-role-to-group-to-permissions, etc. across different enterprise-class systems.

The ability of the engine to take security data (e.g., security principals, user permissions, group permissions, etc.) across different systems and merge the security data in a structured, more granular way allows an enterprise to conduct SoD analyses with system-agnostic rules to reduce the risks of malicious behavior and fraud across the enterprise. Because the security data thus merged and processed conform to a “system-agnostic” object model, analytics can be performed at a more “granular” level to identify potential fraud. For instance, instead of a role-based access review or even a 2-level review, the processed data can be reviewed at four levels, a multi-system review can query for user permissions, group permissions, business functions, and rules (risks)), providing more granularity to better analyze the data for system-wide malicious patterns/activity and, consequently, providing more effective access management. Insights gleaned from a more granular review can be used to report potential issues, in addition to identifying known issues.

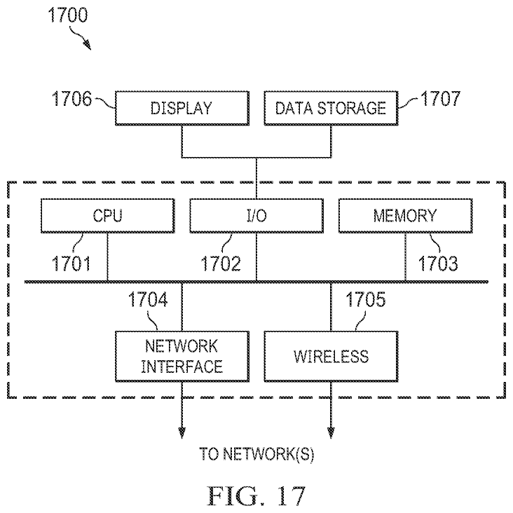

FIG. 17 depicts a diagrammatic representation of a data processing system for implementing an embodiment of an access risk management system disclosed herein. As shown in FIG. 1713, a data processing system 1700 may include one or more central processing units (CPU) or processors 1701 coupled to one or more user input/output (I/O) devices 1702 and memory devices 1703. Examples of I/O devices 1702 may include, but are not limited to, keyboards, displays, monitors, touch screens, printers, electronic pointing devices such as mice, trackballs, styluses, touch pads, or the like. Examples of memory devices 1703 may include, but are not limited to, hard drives (HDs), magnetic disk drives, optical disk drives, magnetic cassettes, tape drives, flash memory cards, random access memories (RAMs), read-only memories (ROMs), smart cards, etc.

The data processing system 1700 can be coupled to display 1706, information device 1707 and various peripheral devices (not shown), such as printers, plotters, speakers, etc. through I/O devices 1702. The data processing system 1700 may also be coupled to external computers or other devices through a network interface 1704, a wireless transceiver 1705, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips.

Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below.

ROM, RAM, and HD are computer memories for storing computer-executable instructions executable by the CPU or capable of being compiled or interpreted to be executable by the CPU. Suitable computer-executable instructions may reside on a non-transitory computer-readable medium (e.g., ROM, RAM, and/or HD), hardware circuitry or the like, or any combination thereof. Within this disclosure, the term “non-transitory computer-readable medium” is not limited to ROM, RAM, and HD and can include any type of data storage medium that can be read by a processor. Examples of non-transitory computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a non-transitory computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a non-transitory computer-readable medium (for example, a disk, CD-ROM, a memory, etc.). Alternatively or additionally, the computer-executable instructions may be stored as software code components on a direct access storage device array, magnetic tape, floppy diskette, optical storage device, or other appropriate non-transitory computer-readable medium or storage device.

Any suitable programming language can be used to implement the routines, methods, or programs of embodiments of the invention described herein, including C, C++, Java, JavaScript, HyperText Markup Language (HTML), Python, or any other programming or scripting code. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components, and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code).

Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise.

The scope of the present disclosure should be determined by the following claims and their legal equivalents.

What is claimed is:

1. A method, comprising:
generating, by an analytics engine embodied on a computer operating in an enterprise computing environment, a security extract metadata file from a system-specific security extract, the system-specific security extract specific to one of a plurality of enterprise-class systems in the enterprise computing environment, the security extract metadata file containing metadata describing security principals and associated permissions;
generating, by the analytics engine, a permissions metadata file from a rulebook, the rulebook specific to a system type and containing a rule and a plurality of business functions governed by the rule, each of the plurality of business functions having a set of permissions and a logical operator, the permissions metadata file containing metadata describing the rule and the plurality of business functions;
analyzing, by the analytics engine, the plurality of business functions as governed by the rule against the security principals and the associated permissions;
determining, by the analytics engine, hits that satisfy the set of permissions and the logical operator; and
storing, by the analytics engine, the hits in a database.

2. The method according to claim 1, wherein the hits comprise at least a user-to-permission hit, a group-to-permission hit, or a role-to-permission hit.

3. The method according to claim 1, wherein the security principals comprise users, roles, groups, or profiles.

4. The method according to claim 1, further comprising:
determining, from the database, a list of permissions on a per user basis across the plurality of enterprise-class systems in the enterprise computing environment, wherein the determining comprises linking a user to a profile or a group, linking the profile or the group to a role, and linking the user to permissions assigned to the role through the profile or the group.

5. The method according to claim 4, wherein the determining further comprises:
linking the user to the role, linking the role to the profile or the group, and linking the user to permissions assigned to the profile or the group through the role.

6. The method according to claim 1, further comprising:
storing the security extract metadata file in a cloud storage; and
storing stub data corresponding to the metadata describing the security principals and the associated permissions in the database, wherein the database is accessible by the analytics engine.

7. The method according to claim 1, further comprising:
storing the permissions metadata file in a cloud storage; and
storing stub data corresponding to the metadata describing the rule and the plurality of business functions in the database, wherein the database is accessible by the analytics engine.

8. A system, comprising:
a processor;
a non-transitory computer-readable medium; and
instructions stored on the non-transitory computer-readable medium and translatable by the processor for:
generating a security extract metadata file from a system-specific security extract, the system-specific security extract specific to one of a plurality of enterprise-class systems in an enterprise computing environment, the security extract metadata file containing metadata describing security principals and associated permissions;
generating a permissions metadata file from a rulebook, the rulebook specific to a system type and containing a rule and a plurality of business functions governed by the rule, each of the plurality of business functions having a set of permissions and a logical operator, the permissions metadata file containing metadata describing the rule and the plurality of business functions;
analyzing the plurality of business functions as governed by the rule against the security principals and the associated permissions;
determining hits that satisfy the set of permissions and the logical operator; and
storing the hits in a database.

9. The system of claim 8, wherein the hits comprise at least a user-to-permission hit, a group-to-permission hit, or a role-to-permission hit.

10. The system of claim 8, wherein the security principals comprise users, roles, groups, or profiles.

11. The system of claim 8, wherein the instructions are further translatable by the processor for:
determining, from the database, a list of permissions on a per user basis across the plurality of enterprise-class systems in the enterprise computing environment, wherein the determining comprises linking a user to a profile or a group, linking the profile or the group to a role, and linking the user to permissions assigned to the role through the profile or the group.

12. The system of claim 11, wherein the determining further comprises:
linking the user to the role, linking the role to the profile or the group, and linking the user to permissions assigned to the profile or the group through the role.

13. The system of claim 8, wherein the instructions are further translatable by the processor for:
storing the security extract metadata file in a cloud storage; and
storing stub data corresponding to the metadata describing the security principals and the associated permissions in the database, wherein the database is accessible by the analytics engine.

14. The system of claim 8, wherein the instructions are further translatable by the processor for:
storing the permissions metadata file in a cloud storage; and
storing stub data corresponding to the metadata describing the rule and the plurality of business functions in the database, wherein the database is accessible by the analytics engine.

15. A computer program product comprising a non-transitory computer-readable medium storing instructions translatable by a processor for:
generating a security extract metadata file from a system-specific security extract, the system-specific security extract specific to one of a plurality of enterprise-class systems in an enterprise computing environment, the security extract metadata file containing metadata describing security principals and associated permissions;
generating a permissions metadata file from a rulebook, the rulebook specific to a system type and containing a rule and a plurality of business functions governed by the rule, each of the plurality of business functions having a set of permissions and a logical operator, the permissions metadata file containing metadata describing the rule and the plurality of business functions;
analyzing the plurality of business functions as governed by the rule against the security principals and the associated permissions;
determining hits that satisfy the set of permissions and the logical operator; and
storing the hits in a database.

16. The computer program product of claim 15, wherein the hits comprise at least a user-to-permission hit, a group-to-permission hit, or a role-to-permission hit.

17. The computer program product of claim 15, wherein the instructions are further translatable by the processor for:
determining, from the database, a list of permissions on a per user basis across the plurality of enterprise-class systems in the enterprise computing environment, wherein the determining comprises linking a user to a profile or a group, linking the profile or the group to a role, and linking the user to permissions assigned to the role through the profile or the group.

18. The computer program product of claim 17, wherein the determining further comprises:
linking the user to the role, linking the role to the profile or the group, and linking the user to permissions assigned to the profile or the group through the role.

19. The computer program product of claim 15, wherein the instructions are further translatable by the processor for:
storing the security extract metadata file in a cloud storage; and
storing stub data corresponding to the metadata describing the security principals and the associated permissions in the database, wherein the database is accessible by the analytics engine.

20. The computer program product of claim 15, wherein the instructions are further translatable by the processor for:
storing the permissions metadata file in a cloud storage; and
storing stub data corresponding to the metadata describing the rule and the plurality of business functions in the database, wherein the database is accessible by the analytics engine.
